(19) United States
(12) Patent Application Publication
(10) Pub. No.: US 2012/0241058 A1
(43) Pub. Date: Sep. 27, 2012

(54) CAST IRON CAST PART AND METHOD FOR PRODUCTION THEREOF

(75) Inventors: Markus Huber, Munchen (DE); Jurgen Mittrach, Feldkirchen (DE); Petra Suess, Munchen (DE); Dirk Radebach, Remscheid (DE)

(73) Assignees: BAYERISCHE MOTOREN WERKE AG, Munchen (DE); NEUE HALBERG-GUSS GMBH, Saarbrucken (DE)

(21) Appl. No.: 13/395,829

(22) PCT Filed: Sep. 22, 2010
(86) PCT No.: PCT/EP2010/005811

§ 371 Date: Jun. 13, 2012

(30) Foreign Application Priority Data
Oct. 5, 2009 (DE) 10 2009 048 273.3

(51) Int. Cl. F16C 3/06; C22C 37/04; C21D 5/00

(52) U.S. Cl. 148/660; 148/321

(57) ABSTRACT

The invention relates to a cast iron cast part, in particular a cast crankshaft (1), having a first layer (3) made of ausferrite, and a second layer (4) adjoining the interior (5) made of ausferrite and troostite.

The present invention relates to a cast iron cast part, in particular a crankshaft and a method for production thereof.

Crankshafts according to the standard EN 1563 are made from cast iron with spheroidal graphite according to the standard EN-GJS 700 or EN-GJS 800, wherein the material EN-GJS 700 has a tensile strength of at least 700 MPa and the material EN-GJS 800 has a tensile strength of at least 800 MPa.

In order to reduce fuel consumption, ignition pressures in an engine are increased through turbo-charging and in order to achieve an additional consumption reduction diameters of straight bearings of crankshafts are reduced as far as possible. This increases the loading of crankshafts even further.

Due to increased loading, crankshafts are often made from forged steel, since steel crankshafts have a higher load bearing capacity than crankshafts made from cast iron with spheroidal graphite. Steel materials have a higher density than cast materials which increases overall weight of the engine. An additional disadvantage of using steel crankshafts is an increase in moving masses. Both effects cause the fuel burn of the motor vehicle to increase. Furthermore, steel crankshafts are typically more expensive than cast crankshafts. Also when optimizing the mass balance with respect to consumption potential, acoustics and installation space, a forged steel crankshaft has a disadvantage over a cast crankshaft in that cavities for weight reduction cannot be provided, thus weight reduction has to be provided e.g. through boring which is expensive.

It is furthermore known to produce crankshafts from ADI (Austempered Ductile Iron) which has an ausferrite structure, this means an austenite structure as well as a ferrite structure.

Thus, the cast iron cast part including spheroidal graphite is heated for several hours to austenizing temperature and then quenched to approximately 350° C. which provides the ausferrite structure.

Crankshafts made from ADI have high tensile strength, toughness and wear resistance. Thick walled cast parts made from ADI like crankshafts, however, require a high percentage of nickel and other expensive alloy components like molybdenum, thus complex cast alloys.

Thus, it is an object of the invention to provide a cast iron cast part, in particular a cast iron crankshaft with high strength, toughness and wear resistance without increasing production cost.

This is provided according to the invention through the cast part according to claim 1. Claims 2 through 5 relate to preferred embodiments of the cast part according to the invention. Claim 6 relates to a preferred method for producing the cast part according to the invention.

According to the invention the cast part has a structure which includes a first layer made from ausferrite at the surface of the cast part, thus a mixed structure including needle ferrite with embedded stabilized residual austenite.

The ausferrite layer at the cast part surface has a tensile strength (Rm) of at least 800 MPa, in particular at least 900 MPa. The elasticity limit (Rp 0.2) of the ausferrite layer is preferably at least 600 MPa, in particular at least 650 MPa.

The tensile strength can also be more than 1000 MPa, however machining can then become more difficult. The layer thickness of the ausferrite layer at the cast part surface is preferably at least 2 mm, in particular at least 4 mm.

Subsequent to the ausferrite layer at the cast part surface which forms the first layer, there comes a second layer towards the interior of the cast part which is made from a mixed structure including ausferrite, thus ferrite and austenite and troostite.

Troostite is a fine stripe perlite. It is provided in a rosetta shape. The fine lamellas of the perlite are only visible under a light microscope with very high magnification. Thus, the lamellas of the troostite in a 200 power magnification only form black spots, this means the particular lamellas are so fine that they are not visible under this magnification.

Through the fine structure troostite has a low internal notch effect. Thus, troostite facilitates achieving high fatigue strength. This is a substantial advantage for highly stressed components like crankshafts.

Depending on the wall thickness of the cast part, the rest of the structure, thus also the interior of the cast part adjacent to the second layer made from ausferrite and troostite can be made from troostite and/or a mixed structure including troostite and perlite which is coarser relative to the perlite. Thus, e.g. in a thicker cast part with a wall thickness of e.g. more than 30 mm there is typically troostite and/or a mixed structure made from troostite and coarser perlite in the interior of the cast part.

This means the cast part according to the invention is made from a gradient material which includes a first layer made from ausferrite at the cast part surface, the second layer made from a mixed structure including ausferrite and troostite and optionally troostite and/or a mixed structure of troostite and perlite which is coarser than the troostite in the interior.

When the cast part according to the invention has been produced with spheroidal graphite GJS as base material, it furthermore includes in both layers, and if provided also the troostite or the coarser perlite in the interior of the cast part include spheroidal graphite. Thus, the graphite spheres are evenly distributed, wherein the minimum is preferably at 100 graphite spheres per mm² and at the most at 0.5% with reference to the cross-sectional surface.

Through the spheroidal graphite the density of the material is reduced relative to a steel material, so that the cast part according to the invention, thus in particular the crankshaft according to the invention is lighter than a crankshaft made from forged steel with the same volume. Furthermore, cavities which can have different configurations in the cast part according to the invention, in particular the crankshaft according to the invention provide substantial weight reduction.

The cast iron from which the cast part according to the invention is produced has the subsequent chemical composition:
3.2 to 3.9% by weight carbon
2.0 to 2.4% by weight silicon
0.6 to 1.3% by weight manganese
0.6 to 1.0% by weight copper
0.030 to 0.050% by weight magnesium
0.0 to 0.1% by weight tin
0.0 to 0.5% by weight nickel
The rest includes iron and common impurities.

This means the cast iron from which the cast part according to the invention is made does not include molybdenum and no nickel or only a very small amount of nickel. Thus the cast iron for producing the cast part according to the invention is not very expensive.

The cast part according to the invention is cast from cast iron with the chemical composition recited supra. After casting and machining to the correct dimension a two step heat treatment is performed.

Thus, the cast part is heated under a protective gas atmosphere to an austenizing temperature of 910° C. to 950° C., in particular approximately 920° C. and kept at this temperature for at least one hour, preferably for at least two hours. Subsequently, the cast component is cooled in a medium with a temperature of approximately 300° C. to 400° C. A salt bath can be used as a cooling medium. The dwelling time in the cooling medium is at least one hour, preferably at least two hours.

Thus, the austenite at the surface of the cast part is converted into an ausferrite layer, thus a mixed structure made from ferrite and residual austenite.

While the layer at the surface of the cast component cools quickly from the austenizing temperature when introduced into the cooling medium, and is thus quenched to form ausferrite at the surface, other cooling conditions are provided towards the interior of the cast component which lead to a formation of the second layer, thus to a conversion of the austenite into ausferrite and troostite and in cast components with large wall thickness this leads to a conversion of the austenite into a troostite structure subsequent to the second layer towards the interior of the cast component and/or a mixed structure including troostite and the perlite that is coarser relative to the troostite.

The cast part according to the invention is preferably a crankshaft for combustion engines, however it can also be e.g. a gear, a pressing tool, a track roller or another highly stressed cast component.

The invention is subsequently described in more detail with reference to the appended drawing figure based on an embodiment of a crankshaft, wherein:

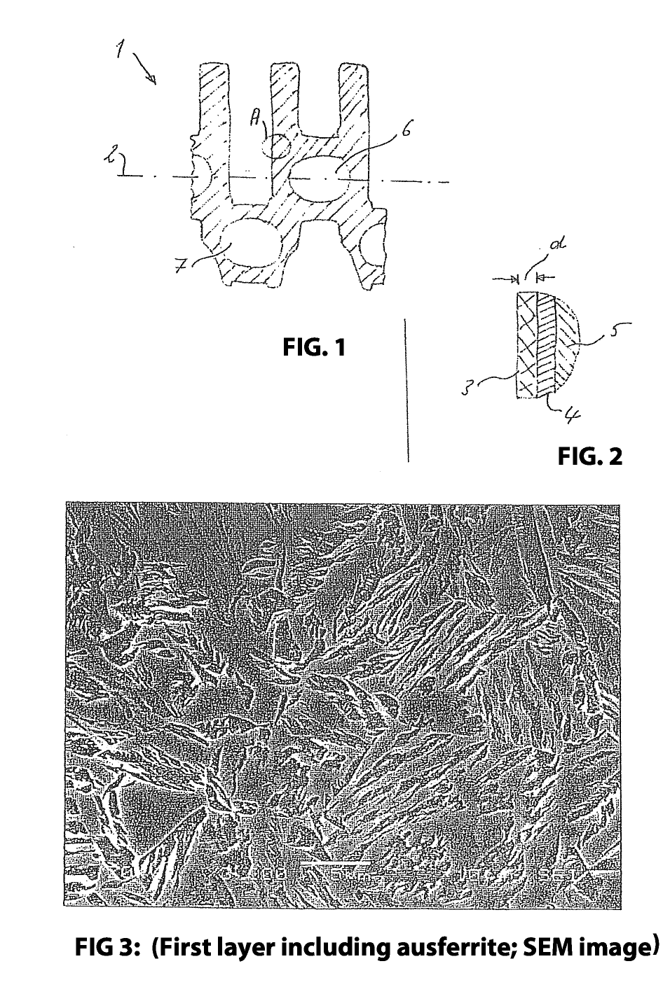

FIG. 1 illustrates a sectional view of a portion of a crankshaft; and

FIG. 2 illustrates an enlarged depiction of the portion A of FIG. 1.

According to FIGS. 1 and 2, a crankshaft 1 with a rotation axis 2 includes a first layer 3 at the surface and a second layer 4 between the first layer 3 and an interior 5 of the crankshaft 1. The reference numerals 6 and 7 designate cavities in the crankshaft 1.

The first layer 3 is made from ausferrite with a layer thickness d of e.g. 5 mm. The second layer 4 is made from a mixed structure including ausferrite and troostite, wherein the interior 5 is formed by troostite and/or a mixed structure including troostite and perlite which is coarser in comparison to troostite.

Through the ausferrite layer 3, the crankshaft 1, in particular also in the highly loaded transition portion at the main bearing and the crank pin bearing where its stressed through bending and torsion, has high strength. The subsequent embodiment is used for describing the invention in more detail.

### EXAMPLE

A crankshaft is cast from cast iron with the following composition:
Carbon 3.5% by weight
Silicon 2.2% by weight
Manganese 0.9% by weight
Copper 0.8% by weight
Magnesium 0.04% by weight
Tin 0.05% by weight
Nickel 0.2% by weight

The cast crankshaft is subjected to a two-step heat treatment method.

Thus, the crankshaft is heated in an oven under a protective gas atmosphere, e.g. argon to a temperature of 920° C. and kept at this temperature for 150 minutes. Subsequently, the cast part thus austenized is quenched in a salt bath to 360 degrees C. and kept therein for 150 minutes and subsequently cooled to ambient temperature.

Tensile strength (Rm) and elasticity limit (Rm 0.2) were determined e.g. according to DIN EN 10002. The ausferrite layer, thus the layer 3 at the surface of the crankshaft 1 according to FIG. 2, has a tensile strength of 920 MPa and an elasticity limit of 660 MPa.

Furthermore, grind images of the ausferrite layer, thus the first layer 3 according to FIG. 2, the second layer 4 of the mixed structure made from ausferrite and troostite and the interior 5 of the crankshaft made from troostite and/or a mixed structure made from troostite and the relatively larger perlite (microscope image) are produced.

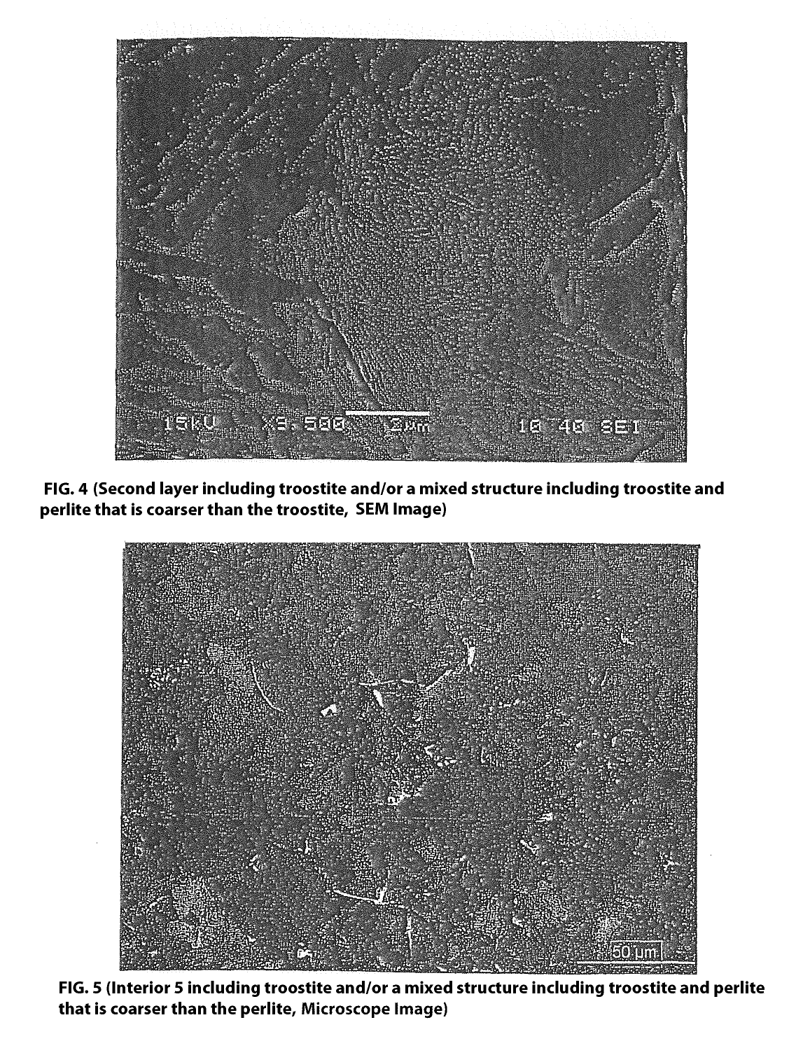

The polished section image of the first layer 3 made from ausferrite is illustrated in FIG. 3. The polished section image of the second layer 4 including the mixed structure including ausferrite and troostite is illustrated in FIG. 4 and the mixed section image of the interior 5 including troostite and/or a mixed structure including troostite and the perlite which is coarser relative to the troostite is illustrated in FIG. 5.

1. A cast iron cast part comprising a structure including a first layer made from ausferrite at a cast part surface and a second layer made from ausferrite and troostite adjacent to the first layer towards an interior of the cast part.

2. The cast iron cast part, according to claim 1, wherein the structure of the interior of the cast part adjacent to the second layer is made from troostite and/or a mixed structure including troostite and perlite that is coarser than the troostite.

3. The cast iron cast part according to claim 1, wherein the first layer made from ausferrite has a tensile strength (Rm) of at least 900 MPa and an elasticity limit (Rp 0.2) of at least 600 MPa.

4. The cast iron cast part according to claim 1, wherein the cast iron cast part includes spheroidal graphite.

5. The cast iron cast part according to claim 1, wherein the cast iron has the following composition:
3.2 to 3.9% by weight carbon
2.0 to 2.4% by weight silicon
0.6 to 1.3% by weight manganese
0.6 to 1.0% by weight copper
0.030 to 0.050% by weight magnesium
0.0 to 0.1% by weight tin
0.0 to 0.5% by weight nickel
The rest includes iron and common impurities.

6. A method for producing a cast iron cast part according to claim 1, wherein a cast iron with spheroidal graphite (GJS) with a composition according to claim 5 is heated in an oven to an austenizing temperature of 910° C. to 950° C. and after a dwelling time of at least 60 minutes is cooled in a medium to a temperature of 300° C. to 400° C. and after a dwelling time in the cooling medium of at least 60 minutes cooled to ambient temperature.

7. The cast iron cast part according to claim 1, wherein the cast iron cast part is formed as a crankshaft.

8. The cast iron cast part according to claim 2, wherein the first layer made from ausferrite has a tensile strength (Rm) of at least 900 MPa and an elasticity limit (Rp 0.2) of at least 600 MPa.

9. The cast iron cast part according to claim 2, wherein the cast iron cast part includes spheroidal graphite.

10. The cast iron cast part according to claim 3, wherein the cast iron cast part includes spheroidal graphite.

11. The cast iron cast part according to claim 2, wherein the cast iron has the following composition:
3.2 to 3.9% by weight carbon
2.0 to 2.4% by weight silicon
0.6 to 1.3% by weight manganese
0.6 to 1.0% by weight copper
0.030 to 0.050% by weight magnesium
0.0 to 0.1% by weight tin
0.0 to 0.5% by weight nickel
The rest includes iron and common impurities.

12. The cast iron cast part according to claim 3, wherein the cast iron has the following composition:
3.2 to 3.9% by weight carbon
2.0 to 2.4% by weight silicon
0.6 to 1.3% by weight manganese
0.6 to 1.0% by weight copper
0.030 to 0.050% by weight magnesium
0.0 to 0.1% by weight tin
0.0 to 0.5% by weight nickel
The rest includes iron and common impurities.

13. The cast iron cast part according to claim 4, wherein the cast iron has the following composition:
3.2 to 3.9% by weight carbon
2.0 to 2.4% by weight silicon
0.6 to 1.3% by weight manganese
0.6 to 1.0% by weight copper
0.030 to 0.050% by weight magnesium
0.0 to 0.1% by weight tin
0.0 to 0.5% by weight nickel
The rest includes iron and common impurities.

14. A method for producing a cast iron cast part according to claim 2, wherein a cast iron with spheroidal graphite (GJS) with a composition according to claim 5 is heated in an oven to an austenizing temperature of 910° C. to 950° C. and after a dwelling time of at least 60 minutes is cooled in a medium to a temperature of 300° C. to 400° C. and after a dwelling time in the cooling medium of at least 60 minutes cooled to ambient temperature.

15. A method for producing a cast iron cast part according to claim 3, wherein a cast iron with spheroidal graphite (GJS) with a composition according to claim 5 is heated in an oven to an austenizing temperature of 910° C. to 950° C. and after a dwelling time of at least 60 minutes is cooled in a medium to a temperature of 300° C. to 400° C. and after a dwelling time in the cooling medium of at least 60 minutes cooled to ambient temperature.

16. A method for producing a cast iron cast part according to claim 4, wherein a cast iron with spheroidal graphite (GJS) with a composition according to claim 5 is heated in an oven to an austenizing temperature of 910° C. to 950° C. and after a dwelling time of at least 60 minutes is cooled in a medium to a temperature of 300° C. to 400° C. and after a dwelling time in the cooling medium of at least 60 minutes cooled to ambient temperature.

17. The cast iron cast part according to claim 2, wherein the cast iron cast part is formed as a crankshaft.

18. The cast iron cast part according to claim 3, wherein the cast iron cast part is formed as a crankshaft.

19. The cast iron cast part according to claim 4, wherein the cast iron cast part is formed as a crankshaft.

20. The cast iron cast part according to claim 5, wherein the cast iron cast part is formed as a crankshaft.
